(19) United States
(12) Patent Application Publication
(10) Pub. No.: US 2005/0106358 A1
(43) Pub. Date: May 19, 2005

(54) Three-dimensional laminate

(76) Inventors: John R. Eshbach JR., Mount Joy, PA (US); Ralph W. Wright JR., Lancaster, PA (US); Craig W. DeSantis, Lititz, PA (US)

Correspondence Address: ARMSTRONG WORLD INDUSTRIES, INC.;LEGAL DEPARTMENT, P. O. BOX 3001, LANCASTER, PA, 17604-3001, US

(21) Appl. No.: 11/006,365

(22) Filed: Dec. 7, 2004

Related U.S. Application Data
(63) Continuation-in-part of application No. 09/644,820, filed on Aug. 18, 2000.

(51) Int. Cl. B32B 1/00

(52) U.S. Cl. 428/143

(57) ABSTRACT

Disclosed are both a decorative laminate and a method for making the decorative laminate. The decorative laminate includes a laminated layer having particulates trapped within a film. The trapped particulates impart the appearance of three-dimensional depth to the decorative laminate. Additionally, a second laminated film having a printed pattern can be laminated to the decorative laminate. The decorative laminate may be formed by laminating a freestanding decorative film composite comprising a particulate embedded film and a print component to a substrate.

### CROSS REFERENCE TO RELATED APPLICATION

This application is a continuation-in-part of U.S. patent application Ser. No. 09/644,820, filed on Aug. 18, 2000.

### FIELD OF THE INVENTION

The present invention relates generally to surface coverings and in particular to a decorative laminate covering.

### BACKGROUND OF THE INVENTION

Sheets of resinous compositions have found widespread use as decorative and wear resistant coverings for a wide range of products. For example, decorative coverings can include coverings for flooring, walls, ceilings, desks, tables and countertops. Additionally, such resinous compositions can be incorporated into surface layers on leather, fabrics, paper, wood, metal and glass, or used in upholstery, drapery, and clothing materials. Sheet materials can also be made with chips or other particulate material.

Generally sheets made with particulate matter fall into two classifications: cushioned or non-cushioned. Cushioned sheets include a substantially continuous layer of foam and are usually made by incorporating solid particulate material into a plastisol coating on top of the foam, followed by gelling and fusing the coating. Non-cushioned sheets do not contain a foam layer and are usually made from sintering or calendering particulate material.

Many processes are known for embedding various particles into a clear PVC plastisol for making decorative patterns. For example, some processes involve the deposition of particles of colored polyvinyl chloride (PVC) having a high carbonate filler or vinyl concentration. Others are arranged to create geometric structures. The particles are placed on the face of the decorative sheet and are then covered by applying a clear plastisol, which can be transparent, translucent or opaque. The plastisol serves as the binding agent between the particles and the decorative sheet.

Additional examples include using flat chips with a higher softening point than a surrounding matrix and then pressing the chips into the matrix without distorting them. Further methods include consolidating chips into a plastisol by pushing cool chips into a relatively hot plastisol and then heating the resulting structure. Chips may also be placed on the surface of a plastisol and allowed to sink near the surface, or chips may be dropped onto a tacky adhesive and then covered with a transparent or translucent liquid thermoplastic film.

Each of these processes requires the step of placing the decorative particulates directly onto the matrix of the covering and then cementing them in place. When forming a decorative laminate it is most cost effective to apply layers as laminated sheets and not as layers that are built up through deposition. Thus, there is a need for creating a particulate embedded laminate that does not require the added step of depositing particulates directly onto the laminate and then cementing them in place.

### SUMMARY OF THE INVENTION

The present invention includes both a decorative laminate and a method for making the decorative laminate. The decorative laminate includes a laminated layer having particulates trapped within a film. The trapped particulates impart the appearance of three-dimensional depth to the decorative laminate.

The method of manufacturing the decorative laminate comprises laminating a substrate, a film having embedded particles and a printed film to form a 3-dimensional laminate. In one embodiment a film having embedded particulates is laminated to a substrate to form a laminated face. A printed film is then laminated to the laminated face to form the three-dimensional laminate.

In another preferred embodiment, a freestanding film composite comprising a particulate embedded film and a printed component is formed. The film composite is then laminated to the substrate to form the decorative laminate. The particulate embedded film comprises a transparent or translucent binder and a plurality of particles embedded in the binder. The print component that is adhered to the particulate embedded film may be a print layer or a printed film.

The printed film comprises a print layer and a transparent or translucent film. The decorative film composite has regions of transparency or translucency so that the when the decorative film composite is adhered to the substrate, a portion of the substrate is visible through the decorative film composite. The print layer of the printed film may be on the side of the film adjacent the particulate embedded film with an optional transparent or translucent layer interposed between the print layer and the particulate embedded film or directly adhered to the particulate embedded film.

The composite structure of the decorative laminate comprises a substrate having a facing side with a particulate embedded film laminated to the facing side of the substrate. Additionally, the decorative laminate includes a printed film laminated to the particulate embedded film.

A further embodiment includes a method of manufacturing a decorative laminate that includes laminating a film having embedded particulates to a substrate to form a laminated face. The film having embedded particulates or the substrate can further comprise a printed pattern.

An additional embodiment includes a decorative laminate having a substrate with a facing side and a particulate embedded film laminated to the facing side of the substrate. The substrate can further comprise a printed pattern on its facing side.

### BRIEF DESCRIPTION OF THE DRAWINGS

FIG. 1 illustrates a cross section of the decorative laminate;

FIG. 2 illustrates an apparatus and method for creating the particulate embedded film which is laminated to the substrate of the decorative laminate of the present invention; and

FIG. 3 illustrates an apparatus and method for creating the decorative laminate.

### DETAILED DESCRIPTION OF THE INVENTION

The present invention includes both a decorative laminate and a method for making the decorative laminate. The decorative laminate comprises a substrate having a facing side with a particulate embedded film laminated to the facing side of the substrate and a printed film laminated to the particulate embedded film. The method of manufacturing the decorative laminate comprises laminating a particulate embedded film to a substrate to form a laminated face and then laminating a printed film with at least regions of translucency or transparency to the laminated face to form a 3-dimensional laminate. The embedded particulates of the decorative laminate provide an added appearance of depth to the laminate.

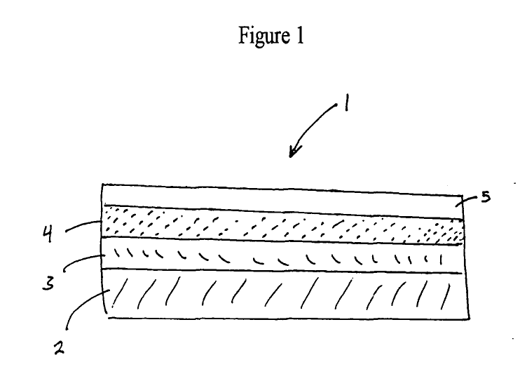

FIG. 1 illustrates a cross section of an embodiment of the decorative laminate 1. Within the drawing there is illustrated four separate layers comprising the decorative laminate. The embodiment shown in FIG. 1 illustrates only one possible embodiment, thus not all the layers shown are required for the present invention.

The substrate layer 2 comprises the base of the decorative laminate 1. The substrate layer 2 can comprise cushioned or non-cushioned sheets and is preferably comprised of a limestone filled vinyl resin composition. The substrate layer 2 has a facing and backing side. Affixed to the facing side is a particulate embedded film 3 and affixed to the backing side can be an adhesive coating (not shown) for installing the decorative laminate 1 to a surface.

The particulate embedded film 3 is preferably a vinyl film wherein particulate matter has been encased within the film. The particulate embedded film is preferably comprised of a vinyl film encompassing particulate matter of either organic or inorganic matter. For example, organic matter can be polyvinyl chloride (PVC) chips and inorganic matter can be marble chips. The term “embedded” is intended to refer to all particulate matter that is either affixed on or within the vinyl film and can also describe matter protruding from the film. The term “particulate” is simply used to denote a substance of matter. The particulate embedded film 3 is laminated to the facing side of the substrate 2 and can either have a printed film 4 laminated to its face, as illustrated in FIG. 1, or a pattern printed directly on its face (not shown). In an alternative embodiment, only a nonprinted topcoat is applied to the particulate embedded film 3.

A printed film 4 is illustrated as being affixed to the face of the particulate embedded film 3 in FIG. 1. The printed film 4 is preferably a back-printed film, such that a pattern is printed on the side of the film to be in contact with the particulate embedded film 3. The printed film 4 is preferably a vinyl film, which is then laminated to the particulate embedded film 3. Additionally, a wear layer or topcoat 5 can be affixed to the facing side of the printed film 4 to provide added wear and protection for the decorative laminate 1.

In greater detail, the substrate 2 can be formed of most any vinyl resin and inorganic filler. Typically, the chosen inorganic filler is limestone. It should be understood that most of the substrates normally employed in the surface covering field may be employed to prepare the laminate of this invention so long as the chosen substrate is relatively strong, durable and flexible. The substrate 2 can also comprise multiple component layers. Thus, most any woven, nonwoven, felted or sheet of synthetic or natural material may also be used as the substrate layer 2.

Essentially, the substrate 2 can be formed of a vinyl blend comprising a free-flowing homogeneous mixture of a thermoplastic vinyl resin, vinyl plasticizers, fillers, pigments, and a vinyl stabilizer. The fillers are typically inorganic matter and may include limestone, silica, diatomaceous earth, clay and mixtures thereof.

The resin component of the substrate is preferably a vinyl resin. More specifically, the vinyl resin is a polymeric material obtained by polymerizing compounds containing at least one —CH═CH₂ radical. Useful vinyl resins include homopolymers, such as polyvinyl chloride, polyvinyl acetate, polyvinyl propionate, polyvinyl butyrate, polymerized vinylidene chloride, polymerized acrylic acid, polymerized ethyl acrylate, polymerized methyl acrylate, polymerized propyl acrylate, polymerized butyl acrylate, polyethylene, polypropylene, and the like; copolymers of the above with each other such as vinyl chloride-vinyl acetate copolymer, vinylidene chloride-vinyl chloride copolymer, methyl methacrylate-vinyl chloride copolymer, methyl acrylate-ethyl acrylate copolymer, ethyl acrylate-butyl acrylate copolymer, ethylene propylene copolymers, ethylene styrene copolymers, and the like and copolymers of the above with other monomers copolymerizable therewith, such as vinyl esters, including vinyl bromide, vinyl fluoride, vinyl chloroacetate, vinyl alkyl sulfonates, trichloroethylene and the like; vinyl ethers such as vinyl ethyl ether, vinyl isopropyl ether, vinyl chloroethyl ether and the like; cyclic unsaturated compounds such as styrene, chlorostyrene, coumarone, vinyl pyridine and the like; maleic and fumaric acid and their derivatives such as diethyl maleate, dibutyl fumarate and the like; unsaturated hydrocarbon such as ethylene, propylene, butylene and the like; allyl compounds such as allyl acetate, allyl chloride, allyl ethyl ether, and the like; conjugated and cross-conjugated unsaturated compounds such as butadiene, isoprene, chloroprene, 2,3-dimethylbutadiene-1,3, divinyl ketone and the like. The monomers listed above are useful in preparing copolymers with a vinyl resin and can be used as modifiers in the polymerization, in which case they may be present in an amount of a few percent, or they can be used in larger quantities, up to as high as 40 percent by weight of the mixture to be polymerized.

A plasticizer for the vinyl resin may be added to the vinyl resin of the substrate. Suitable plasticizers for the vinyl resin include ester type plasticizers such as tributyl phosphate, dioctyl phthalate, dipropylene glycol dibenzoate, phenyl phosphate, dibutyl tartrate, amyl tartrate, butyl benzyl benzoate, dibutyl sebacate, dioctyl adipate, didecyl adipate and the like, rubbery plasticizers, such as butadiene-styrene copolymer, butadiene-acrylonitrile copolymer, ethylene vinyl acetate (EVA), and the like, and other materials which function as plasticizers, such as epoxidized drying oils, aromatic hydrocarbon condensates and the like. Where certain flexible soft vinyl resins are used, such as polymers containing large proportions of ethyl acrylate, no plasticizer is needed.

The particulate embedded film may be formed from most any plastisol, organosol, or melt processed vinyl resin material. For example, the plastisol or organosol may be a thermoplastic polymer or homopolymer of polyvinyl chloride, a copolymer of polyvinyl chloride and one or more other co-polymerizable resins, a block polymer of polyvinyl chloride and one or more other co-polymerizable resins, a graft polymer of polyvinyl chloride and one or more other co-polymerizable resins. Additionally, an acrylic resin capable of being dispersed into a plastisol may be included. Melt processable materials can include homopolymers or copolymers of polyvinyl chloride, a polyamide, a polyester, polyolefins such as ethylene, propylene or polystyrene, a polycarbonate, and an acrylic. The particulate embedded film may have most any thickness that is practical for application. For example, in one embodiment, the film may have a thickness ranging between 1/16 to ⅛ inches. In another embodiment the film may have a thickness ranging from 5 to 20 mils. The vinyl film may be substantially clear or substantially opaque. The opaque film may contain pigments for providing color or contrast.

The embedded particulates are intended to give the resulting decorative laminate a 3-deminsional appearance such that the particulates give the illusion of depth to the decorative laminate. The particulates are primarily chosen for their decorative value, thus most any particle may serve such purpose. For example, the particulates may be formed of polymeric compositions, resinous compositions, mica, ceramics, metals, rubbers and combinations. The particulates may also be substantially clear or substantially opaque. They can contain traditional pigments or enhanced pigments such as pearlescent pigments to provide color and contrast. In one embodiment, it is desired that the particulates be opaque when the film is clear and clear when the film is opaque.

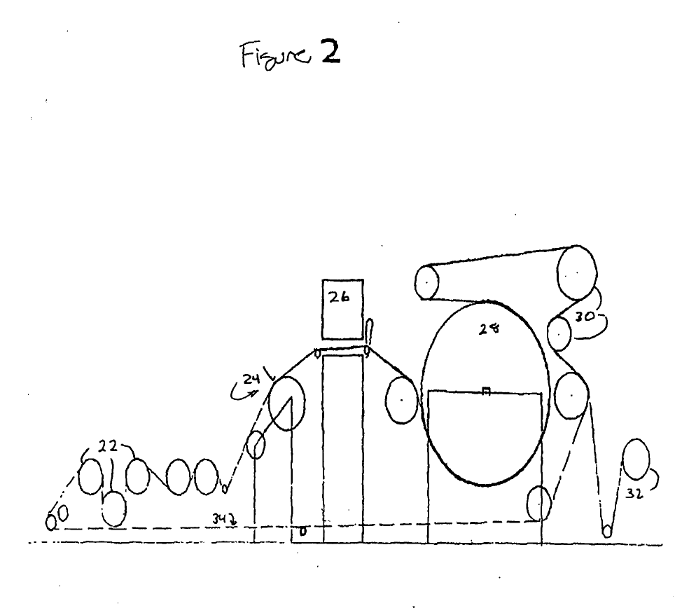

As illustrated in FIG. 2, the particulate embedded film 3 can be manufactured as a gelled plastisol sheet film made in a continuous process. The use of release paper or felt carrier is not needed since the continuous belt 34 is preferably coated with a non-stick surface material such as silicone or Teflon® which provides a sufficient release surface for the plastisol sheet. Of course, release paper or felt can be used, but such is not preferred since both are essentially single use release agents and add to the cost of processing the film.

The dancer rolls 22 provide the initial tension in the continuous belt 34. The dancer rolls 22 are followed by a blade over roll coater assembly 24 which coats the continuous belt 34 with the plastisol. Other coating devices such as roll coaters, screen coaters, etc. can be utilized. The chip feeder 26 next distributes the particulates or chips onto the plastisol. The chips may be distributed at random or in a desired pattern. After the chips have been distributed, the continuous belt 34 then proceeds to a large heated drum 28 where the plastisol is gelled and fused to the particulates to create the particulate embedded film. The film can then be cooled over cooling rollers 30 and separated from the continuous belt 34 in the wind up 32. This example is only given to illustrate and teach one possible method of creating a particulate embedded film. It is recognized that there are other possible methods of creating a particulate embedded film including melt processing methods.

The printed film 4 is preferably a back-printed film wherein the inked side of the film is in contact with the particulate embedded film. The printed film is laminated to the particulate embedded film and is preferably comprised of a substantially clear acrylic or polyvinyl chloride film having a printed pattern. In an alternative embodiment, the film may also contain pigments. Pigmentation is preferably limited to colorations that do not substantially obscure the printed matter on the film. The non-printed side of the printed film can perform as the wearlayer in the final product structure, or in a further embodiment, the printed film further contains a topcoat on the non-printed side of the film. The composition of the topcoat is not limited, but is preferably formed from compositions such as those described in U.S. Pat. Nos. 5,843,576, 5,543,232, and 5,719,227 which are incorporated herein by reference. U.S. Pat. No. 5,843,576 specifically discloses floor coverings that include a wear layer made from a coating composition including a multifunctional polyurethane (meth)acrylate oligomer.

In an alternative embodiment, a printed pattern may be printed directly onto the upper surface (face) of the particulate embedded film. The pattern can be printed before the particulate embedded film is laminated to the substrate or after lamination. A wear layer or a topcoat can be subsequently directly applied or laminated to the facing side of the particulate embedded film.

In another embodiment, the face of substrate 2 can comprise a printed pattern that can be used in combination with the embedded film 3 and printed film 4 to produce enhanced visual effects. For example, if the substrate 2 comprises a chemically embossable foamable layer, the printed pattern can contain chemical embossing inhibitors or accelerators to impart a texture to the final structure after heating and further processing of the laminated composite. Alternatively, the bottom side of the particulate embedded film 3 can be printed with a design using chemical embossing inhibitors or accelerators, to similarly impart a texture to the final structure containing a chemically embossable foamable layer, after heating and further processing of the laminated composite. Chemical embossing inhibitor and accelerator technology is described in U.S. Pat. Nos. 3,292,108, 4,147,104, and 4,264,957, which are incorporated herein by reference.

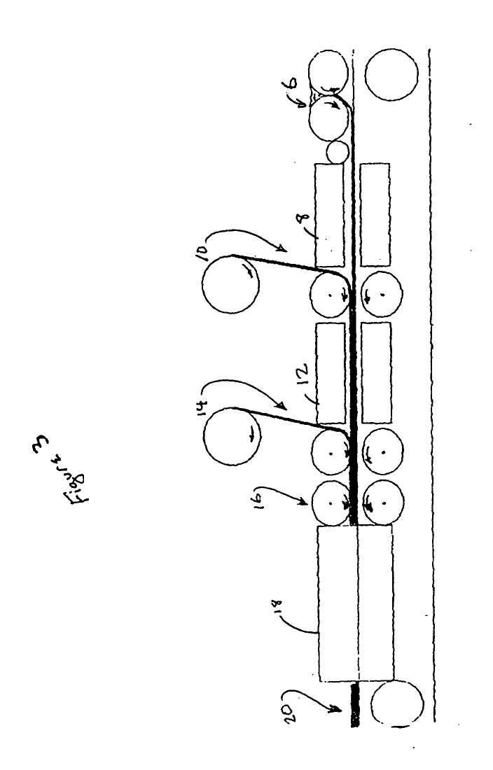

Illustrated in FIG. 3, a method and apparatus are described for creating a decorative laminate of the present invention. The illustrated process comprises two separate lamination steps. The first lamination step comprises laminating the particulate embedded film 3 to the substrate 2 and the second step comprises laminating the printed film 4 to the embedded film 3. Once laminated, the decorative laminate can be embossed and punch pressed into decorative tiles.

In greater detail, the substrate layer 2 is formed in the mill 6. A heated fluxed mixture of vinyl resin and limestone filler is placed on mill 6 to form a substrate sheet that is then heated to a temperature between about 275° F. to about 325° F. in a set of heaters 8. The heaters 8 can be of any radiant devise, gas, or other heat source. Once heated, the substrate 2 is laminated with the particulate embedded film 3 in the first lamination station 10. Once laminated, the laminated substrate is then heated again in a second set of heaters 12 to a temperature between about 275° F. to about 325° F. Once heated, the laminated substrate is then laminated with the printed film 4 in a second lamination station 14. After the second lamination station 14, the decorative laminate may then be embossed with a desired design before the laminate cools. The laminate is embossed mechanically using various embossing rollers 16. This embossing can be in-register with the print pattern or an overall embossing texture. Once embossed, the laminate can be cooled in a water bath 18 and then punched into decorative tiles by punch press 20. The above example is given to illustrate one embodiment of creating the decorative laminate 1. It is recognized that there can be additional steps added to the described process, including the step of printing a pattern directly on the particulate embedded film 3 instead of laminating the printed film 4 or in addition to the printed film 4. Additionally, if a cushioned sheet substrate 2 is employed, chemical as well as mechanical embossing techniques and processes can be employed.

While specification embodiments have set forth as illustrated and described above, it is recognized that variations may be made with respect to disclosed embodiments. These can include other known continuous or discontinuous process variations, as well as the use of compatible adhesive layers in the lamination processes. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

1. A freestanding decorative film composite comprising
a particulate embedded film comprising a transparent or translucent binder and a plurality of particles embedded in the binder and
a printed component adhered to the particulate embedded film, the printed component consisting of a component selected from the group consisting of a print layer and a printed film comprising a print layer adhered to a transparent or translucent film, the printed component having an regions of translucency or transparency, whereby the decorative film composite has regions of translucency or transparency.

2. The film composite of claim 1, wherein the print layer of the printed film is adjacent the particulate embedded film.

3. The film composite of claim 2, wherein the print layer of the printed film is adhered directly to the particulate embedded film.

4. The film composite of claim 1, further comprising a multifunctional polyurethane (meth)acrylate oligomer wear layer adhered to the print component opposite the particulate embedded film.

5. The film composite of claim 4, wherein the print layer of the printed film is adjacent the particulate embedded film.

6. The film composite of claim 5, wherein the print layer of the printed film is adhered directly to the particulate embedded film.

7. The film composite of claim 1, wherein the film composite has a mechanically embossed surface texture.

8. The film composite of claim 7, wherein the mechanically embossed surface texture is embossed in register with a printed pattern of the printed film or a pattern formed by the particulates of the particulate embedded film.

9. The film composite of claim 1, wherein the embedded particles comprise chips.

10. The film composite of claim 1, wherein the binder of the particulate embedded film is comprises a polyvinyl chloride.

11. The film composite of claim 1, wherein the particulate embedded film comprises a pigment.

12. The film composite of claim 1, wherein the binder is selected from the group consisting of a plastisol, organosol, and a melt processed composition of thermoplastic polymer.

13. The film composite of claim 1, wherein the particulate embedded film contains particulates which are translucent, opaque, or a combination thereof.

14. The film composite of claim 1, wherein the particles comprise a material selected from the group consisting of a resinous composition, mica, ceramic, metal and combinations thereof.

15. The film composite of claim 1, further comprising a printed pattern applies to the particulate embedded film opposite the print component.

16. The film composite of claim 1, wherein the printed pattern comprises a component selected from the group consisting of a chemical embossing inhibitor, a chemical embossing accelerator and a combination thereof.

17. The film composite of claim 1, further comprising a wear layer adhered to the print component opposite the particulate embedded film.

18. A flooring structure component comprising the film composite of claim 1 and an adhesive layer adhered to the particulate embedded film opposite the print component.

19. The flooring structure component of claim 18, further comprising a release sheet adhered to the adhesive layer.
